(19) United States
(12) Patent Application Publication
(10) Pub. No.: US 2018/0330853 A1
(43) Pub. Date: Nov. 15, 2018

(54) METHOD FOR PRODUCING RARE-EARTH MAGNET, AND RARE-EARTH MAGNET

(71) Applicant: Sumitomo Electric Industries, Ltd., Osaka-shi (JP)

(72) Inventors: Shigeki Egashira, Itami-shi (JP); Kazunari Shimauchi, Itami-shi (JP); Toru Maeda, Itami-shi (JP)

(21) Appl. No.: 15/776,819

(22) PCT Filed: Nov. 14, 2016
(86) PCT No.: PCT/JP2016/083679

§ 371 Date: May 17, 2018

(30) Foreign Application Priority Data
Nov. 19, 2015 (JP) 2015-227121

(51) Int. Cl. H01F 1/059; C22C 38/00; B22F 1/00; B22F 9/02; H01F 41/02

(52) U.S. Cl. CPC H01F 1/059; C22C 38/005; B22F 1/0011; B22F 9/04; H01F 41/0266; C22C 2202/02; B22F 9/023

(57) ABSTRACT

A method for producing a rare-earth magnet includes a provision step of providing a Sm—Fe-based alloy containing a SmFe_{9+α} phase serving as a main phase by rapidly cooling a molten alloy containing Sm and Fe in an atomic ratio of 1:8.75 to 1:12, a hydrogenation-disproportionation step of subjecting the Sm—Fe-based alloy to hydrogenation-disproportionation treatment to allow part of the SmFe_{9+α} phase (α=0.1 to 3.0) to undergo phase decomposition into SmH₂ and Fe, a formation step of pressure-forming the Sm—Fe-based alloy that has been subjected to the hydrogenation-disproportionation treatment to provide a formed article, a desorption-recombination step of subjecting the formed article to desorption-recombination treatment to allow the SmH₂ and the Fe provided by phase decomposition in the hydrogenation-disproportionation treatment to recombine, and a nitriding step of subjecting the formed article that has been subjected to the desorption-recombination treatment to nitriding treatment, in which when the Sm—Fe-based alloy obtained in the provision step is subjected to X-ray diffraction, the integrated intensity ratio of the integrated intensity Int(Fe) of a diffraction peak arising from the α-Fe(110) plane to the integrated intensity Int(SmFe) of a maximum diffraction peak arising from a compound of Sm and Fe is 1/9 or less in a range of 2θ=30° to 50°.

### TECHNICAL FIELD

The present disclosure relates to a method for producing a rare-earth magnet and to a rare-earth magnet. The present application claims priority to Japanese Patent Application No. 2015-227121 filed in the Japan Patent Office on Nov. 19, 2015, which is hereby incorporated by reference herein in its entirety.

### BACKGROUND ART

Rare-earth magnets containing rare-earth-iron-based alloys that contain rare-earth elements and iron and that contain rare-earth-iron-based compounds serving as main phases are widely used as permanent magnets used for motors and power generators. Typically, Nd—Fe—B-based magnets (neodymium magnets) containing Nd—Fe—B-based compounds (for example, Nd₂Fe₁₄B) serving as main phases and Sm—Fe—N-based magnets containing Sm—Fe—N-based compounds (for example, Sm₂Fe₁₇N₃) serving as main phases are known as rare-earth magnets (for example, see PTLs 1 and 2).

### CITATION LIST

### Patent Literature

PTL 1: Japanese Unexamined Patent Application Publication No. 10-312918

PTL 2: Japanese Unexamined Patent Application Publication No. 2015-128118

### SUMMARY OF INVENTION

A method for producing a rare-earth magnet according to the present disclosure includes the following steps:

(A) a provision step of providing a Sm—Fe-based alloy containing a SmFe_{9+α} phase serving as a main phase, the SmFe_{9+α} phase (α=0.1 to 3.0) having a mixed crystal structure including a SmFe₉ phase and amorphous Fe, by rapidly cooling a molten alloy containing Sm and Fe as main components in an atomic ratio of 1:8.75 to 1:12;
(B) a hydrogenation-disproportionation step of subjecting the Sm—Fe-based alloy to hydrogenation-disproportionation treatment by heat treatment in a hydrogen-containing atmosphere to decompose part of the SmFe_{9+α} phase into two phases of SmH₂ and Fe through a disproportionation reaction;
(C) a formation step of pressure-forming the Sm—Fe-based alloy that has been subjected to the hydrogenation-disproportionation treatment to provide a formed article;
(D) a desorption-recombination step of subjecting the formed article to desorption-recombination treatment by heat treatment in an inert atmosphere or a reduced-pressure atmosphere to allow the SmH₂ and the Fe provided by phase decomposition in the hydrogenation-disproportionation treatment to recombine through a recombination reaction; and
(E) a nitriding step of subjecting the formed article that has been subjected to the desorption-recombination treatment to nitriding treatment by heat treatment in a nitrogen-containing atmosphere.

When the Sm—Fe-based alloy obtained in the provision step is subjected to X-ray diffraction with a Cu tube serving as a radiation source, an integrated intensity ratio of integrated intensity Int(Fe) of a diffraction peak arising from an α-Fe(110) plane to integrated intensity Int(SmFe) of a maximum diffraction peak arising from a compound of Sm and Fe is 1/9 or less in a range of 2θ=30° to 50°.

A rare-earth magnet according to the present disclosure has a nanocomposite mixed crystal microstructure including an Fe phase, a Sm₂Fe₁₇Nₓ phase, and a SmFe₉N_{y} phase, in which the rare-earth magnet has a relative density of 80% or more.

### BRIEF DESCRIPTION OF DRAWINGS

FIG. 1 is a schematic diagram of the crystalline microstructure of a Sm—Fe-based alloy after hydrogenation-disproportionation treatment in a method for producing a rare-earth magnet according to an embodiment.

FIG. 2 is a schematic diagram of the crystalline microstructure of a formed article after desorption-recombination treatment in a method for producing a rare-earth magnet according to an embodiment.

FIG. 3 is a schematic diagram of the crystalline microstructure of a rare-earth magnet after nitriding treatment in a method for producing a rare-earth magnet according to an embodiment.

### DESCRIPTION OF EMBODIMENTS

Examples of rare-earth magnets mainly used include sintered magnets each produced by sintering a rare-earth-iron-based alloy magnetic powder using pressure forming; and bonded magnets each produced by mixing a rare-earth-iron-based magnetic powder with a binder and subjecting the resulting mixture to pressure forming to cure the binder. In the case of Sm—Fe—N-based magnets, these are usually used in the form of bonded magnets (see PTL 1). The reason for this is as follows: when Sm—Fe—N-based compounds are sintered, the compounds are decomposed to fail to provide the performance of magnets because of their low decomposition temperatures.

A compacted magnet produced by subjecting a rare-earth-iron-based magnetic powder to pressure forming is reported (see PTL 2). In PTL 2, the rare-earth-iron-based powder serving as a raw material is subjected to hydrogenation-disproportionation (HD) treatment and then pressure forming to form a compact. The compact is subjected to desorption-recombination (DR) treatment and then nitriding treatment to produce a rare-earth magnet. According to the technique described in this literature, the hydrogenation-disproportionation treatment of the rare-earth-iron-based alloy improves formability, and the pressure forming of the alloy powder that has been subjected to the hydrogenation-disproportionation treatment provides a high-density compact, thus enabling an increase in the density of the rare-earth magnet.

Sm—Fe—N-based rare-earth magnets have been required to have higher performance. There has been a strong demand for the development of a rare-earth magnet having good magnetic properties.

The inventors have conducted intensive studies on an improvement in the magnetic properties of a Sm—Fe—N-based rare-earth magnet and have reached findings below.

In general, conventional Sm—Fe—N-based bonded magnets contain binders and thus have low relative density. Accordingly, percentages of Sm—Fe—N-based alloy magnetic powders therein are low, thus leading to degraded magnetic properties. The operating temperatures of the magnets are limited to the upper temperature limits of binders. Thus, the upper temperature limits of the magnets are disadvantageously low, limiting the range of use.

Because compacted magnets do not require any binder, the foregoing problems of bonded magnets can be solved by the use of the foregoing technique for a compacted magnet. In the method for producing a compacted Sm—Fe—N-based magnet, a Sm—Fe-based alloy powder serving as a raw material is subjected to hydrogenation-disproportionation treatment to decompose a Sm—Fe-based compound through a disproportionation reaction into two phases of SmH₂ and Fe, resulting in a mixed crystal microstructure including these phases. Accordingly, the presence of the Fe phase, which is softer than the Sm—Fe-based compound and SmH₂, results in an improvement in formability.

The inventors have developed conventional techniques for compacted magnets and have attempted to improve magnetic properties by the formation of a nanocomposite in order to produce a rare-earth magnet having higher performance. The formation of a nanocomposite refers to the formation of a nanocomposite microstructure including nano-sized fine soft and hard magnetic phases, both phases being combined together on the order of nanometers. An example of the soft magnetic phase is Fe. Examples of the hard magnetic phase include Sm—Fe-based compounds (e.g., Sm₂Fe₁₇N₃, and SmFe₉N_{1.8}). Owing to the formation of a nanocomposite, the soft magnetic phase is pinned to the hard magnetic phase by the exchange interaction between the soft magnetic phase and the hard magnetic phase, so that the soft and hard magnetic phases behave like a single-phase magnet.

Accordingly, the resulting nanocomposite has high magnetization arising from the soft magnetic phases and a high coercive force arising from the hard magnetic phases and thus has improved magnetic properties such as remanent magnetization and coercive force.

However, a conventional method for producing a compacted magnet mainly aims to improve the formability. The heat-treatment temperature in the hydrogenation-disproportionation treatment is basically set at a relatively high temperature, and the whole of the Sm—Fe-based compound is seemingly subjected to phase decomposition. Specifically, the heat-treatment temperature in the hydrogenation-disproportionation treatment is set at a temperature higher than a temperature at which the peak of the disproportionation reaction is obtained. In this case, phases provided by the hydrogenation-disproportionation treatment are coarsened, and when SmH₂ and Fe provided by phase decomposition in the hydrogenation-disproportionation treatment are recombined together by a recombination reaction in a desorption-recombination treatment after the hydrogenation-disproportionation treatment, a coarse Fe phase having an average grain size of more than 300 nm is formed. The presence of the coarse Fe phase in the microstructure disadvantageously decreases the effect of the formation of a nanocomposite on an improvement of magnetic properties. Accordingly, if the Fe phase formed by the desorption-recombination treatment can be refined, the magnetic properties seem to be significantly improved to provide a compacted rare-earth magnet having high remanent magnetization and high coercive force.

The inventors have found that in the case where a specific Sm—Fe-based alloy is used as a starting material and where conditions of the hydrogenation-disproportionation treatment are optimized, a fine nanocomposite microstructure can be formed to provide a compacted rare-earth magnet having good magnetic properties. The present invention has been accomplished based on the foregoing findings. Embodiments according to the present disclosure are first listed and explained.

### 1. Description of Embodiments

(1) A method for producing a rare-earth magnet according to the present disclosure includes the following steps:
(A) a provision step of providing a Sm—Fe-based alloy containing a SmFe_{9+α} phase serving as a main phase, the SmFe_{9+α} phase (α=0.1 to 3.0) having a mixed crystal structure including a SmFe₉ phase and amorphous Fe, by rapidly cooling a molten alloy containing Sm and Fe as main components in an atomic ratio of 1:8.75 to 1:12;
(B) a hydrogenation-disproportionation step of subjecting the Sm—Fe-based alloy to hydrogenation-disproportionation treatment by heat treatment in a hydrogen-containing atmosphere to decompose part of the SmFe_{9+α} phase into two phases of SmH₂ and Fe through a disproportionation reaction;
(C) a formation step of pressure-forming the Sm—Fe-based alloy that has been subjected to the hydrogenation-disproportionation treatment to provide a formed article;
(D) a desorption-recombination step of subjecting the formed article to desorption-recombination treatment by heat treatment in an inert atmosphere or a reduced-pressure atmosphere to allow the SmH₂ and the Fe provided by phase decomposition in the hydrogenation-disproportionation treatment to recombine through a recombination reaction; and
(E) a nitriding step of subjecting the formed article that has been subjected to the desorption-recombination treatment to nitriding treatment by heat treatment in a nitrogen-containing atmosphere.

When the Sm—Fe-based alloy obtained in the provision step is subjected to X-ray diffraction with a Cu tube serving as a radiation source, an integrated intensity ratio of integrated intensity Int(Fe) of a diffraction peak arising from an α-Fe(110) plane to integrated intensity Int(SmFe) of a maximum diffraction peak arising from a compound of Sm and Fe is 1/9 or less in a range of 2θ=30° to 50°.

In the method for producing a rare-earth magnet, the Sm—Fe-based alloy containing Sm and Fe serving as main components is used as a raw material. The Sm—Fe-based alloy is subjected to the hydrogenation-disproportionation treatment, pressure forming, and desorption-recombination treatment to produce a binder-free, high-density rare-earth magnet. For example, a relative density of 80% or more can be achieved. Furthermore, in the case where a specific Sm—Fe-based alloy is used as a raw material and where conditions of the hydrogenation-disproportionation treatment are set such that part of the SmFe_{9+α} phase is subjected to phase decomposition and such that the undecomposed SmFe_{9+α} phase is left, the coarsening of the phases provided by phase decomposition can be inhibited. Thus, the formation of a coarse Fe phase in the desorption-recombination treatment can be inhibited to form a fine nanocomposite microstructure. Accordingly, by the method for producing a rare-earth magnet, a remanent magnetization having good magnetic properties can be produced. The mechanism of the method for producing a rare-earth magnet will be described.

The Sm—Fe-based alloy, which is a raw material, provided in the provision step is produced by rapidly cooling the molten alloy containing Sm and Fe in an atomic ratio (Fe/Sm) of 8.75 or more and 12 or less. The rapid cooling provides the SmFe₉ phase, which is a metastable phase and is more unstable than a Sm₂Fe₁₇ phase, thereby producing the SmFe_{9+α} phase having the mixed crystal structure including the SmFe₉ phase and the amorphous Fe. The amorphous Fe is not observed by the X-ray diffraction and is present in grains of the SmFe₉ phase in a dispersed state.

In the Sm—Fe-based alloy serving as a raw material, the integrated intensity ratio (Int(Fe)/Int(SmFe)) is 1/9 or less, and the amount of α-Fe precipitated in the alloy is low. The term “SmFe_{9+α}” used here indicates that the number of atoms of Fe per atom of Sm is 9+α, and 0.1≤α≤3.0.

In the hydrogenation-disproportionation treatment, part of the SmFe_{9+α} phase is decomposed by the hydrogenation-disproportionation treatment into the two phases of SmH₂ and Fe, thereby providing a hydrogenated alloy having a mixed crystal microstructure including the Fe phase, the SmH₂ phase, and the unreacted SmFe₉ phase. The Sm—Fe-based alloy (hydrogenated alloy) that has been subjected to the hydrogenation-disproportionation treatment is press-formed in the formation step into a formed article. In the desorption-recombination step, the formed article is subjected to the desorption-recombination treatment to allow SmH₂ and Fe provided by phase decomposition in the hydrogenation-disproportionation treatment to recombine, thereby forming a mixed crystal body having a nanocomposite mixed crystal microstructure including an Fe phase, the Sm₂Fe₁₇ phase, and the SmFe₉ phase. When only part of the SmFe_{9+α} phase is subjected to phase decomposition in the hydrogenation-disproportionation treatment, the coarsening of the Fe phase is inhibited to inhibit the formation of a coarse Fe phase in the desorption-recombination treatment. For example, an average grain size of the Fe phase of 200 nm or less, even 100 nm or less can be achieved. Then the nitriding treatment of the formed article (mixed crystal body) that has been subjected to the desorption-recombination treatment nitrides the Sm₂Fe₁₇ phase and the SmFe₉ phase to provide a rare-earth magnet having a nanocomposite mixed crystal microstructure including the Fe phase, the Sm₂Fe₁₇Nₓ phase, and the SmFe₉N_{y} phase.

(2) In an embodiment of the method for producing a rare-earth magnet, in the hydrogenation-disproportionation step, the Sm—Fe-based alloy that has been subjected to the hydrogenation-disproportionation treatment has a content of the SmFe₉ phase of 35% or more by volume and 60% or less by volume.

When the Sm—Fe-based alloy (hydrogenated alloy) that has been subjected to the hydrogenation-disproportionation treatment contains the SmFe₉ phase in the above range, the enhancement of the formability and the refinement of the microstructure can both be achieved. A lower percentage of the SmFe₉ phase results in a larger amount of the Fe phase formed by the phase decomposition of the SmFe_{9+α} phase to lead to an improvement in formability; however, the Fe phase tends to coarsen to degrade the magnetic properties. In other words, a higher percentage of the SmFe₉ phase results in a higher percentage of the remaining SmFe_{9+α} phase unreacted to cause a difficulty in plastic deformation and to degrade the formability; however, the coarsening of the Fe phase tends to be inhibited to form a fine nanocomposite microstructure. A percentage of the SmFe₉ phase of 35% or more by volume results in effective improvements in magnetic properties owing to the refinement of the microstructure while achieving higher density. A percentage of the SmFe₉ phase of 60% or less by volume sufficiently enhances the formability.

(3) The method for producing a rare-earth magnet according to an embodiment further includes a pulverization step of pulverizing the Sm—Fe-based alloy before the formation step.

The pulverization of the Sm—Fe-based alloy into a powder increases the flowability of the alloy when the alloy is charged into a die set in the formation step, thereby facilitating the charging operation. The pulverization step may be performed before the formation step. The Sm—Fe-based alloy serving as a raw material may be pulverized. Alternatively, the Sm—Fe-based alloy that has been subjected to the hydrogenation-disproportionation treatment may be pulverized. That is, the pulverization step is performed before or after the hydrogenation-disproportionation step.

(4) In an embodiment of the method for producing a rare-earth magnet, the heat treatment in the hydrogenation-disproportionation step is performed at a temperature higher than 500° C. and lower than 650° C.

When the heat-treatment temperature in the hydrogenation-disproportionation treatment is within the range described above, part of the SmFe_{9+α} phase is easily and effectively subjected to phase decomposition. A temperature at which a peak of the disproportionation reaction of the Sm—Fe-based alloy (SmFe_{9+α} phase) is obtained is about 650° C., depending on composition. The range described above is lower than that the temperature. The heat-treatment temperature in the hydrogenation-disproportionation treatment is more preferably 525° C. or higher and 625° C. or lower.

(5) In an embodiment of the method for producing a rare-earth magnet, in the provision step, the Sm—Fe-based alloy is produced by rapid cooling using a melt-spinning method.

Because the Sm—Fe-based alloy is produced by rapid cooling using the melt-spinning method, the Sm—Fe-based alloy containing the SmFe_{9+α} phase serving as a main phase can be industrially produced, the SmFe_{9+α} phase having the mixed crystal structure including the SmFe₉ phase and amorphous Fe.

(6) A rare-earth magnet according to the present disclosure includes a nanocomposite mixed crystal microstructure including an Fe phase, a Sm₂Fe₁₇Nₓ phase, and a SmFe₉N_{y} phase, in which the rare-earth magnet has a relative density of 80% or more.

The rare-earth magnet has a Fe/Sm₂Fe₁₇Nₓ/SmFe₉N_{y} nanocomposite mixed crystal microstructure and a relative density of 80% or more; thus, the rare-earth magnet has high remanent magnetization and high coercive force and has good magnetic properties. Because the rare-earth magnet includes a soft magnetic phase formed of the Fe phase, hard magnetic phases formed of the Sm₂Fe₁₇Nₓ phase and the SmFe₉N_{y} phase, and the fine nano-sized Fe phase, the exchange interaction between the soft magnetic phase and the hard magnetic phases enables the rare-earth magnet to have both high magnetization and high coercive force. The Fe phase has average grain size of, for example, 200 nm or less, even 100 nm or less. Because the relative density is 80% or more, the percentage of the Sm—Fe—N-based alloy is high, thereby providing performance close to intrinsic magnetic properties of the Sm—Fe—N-based alloy.

The atomic ratio x of N in Sm₂Fe₁₇Nₓ is, for example, 2.0≤x≤3.5, preferably x=3. The atomic ratio y of N in SmFe₉N_{y} is, for example, 0.5≤y≤2.0, preferably y=1.8.

### 2. Detail of Embodiment

Specific embodiments of the method for producing a rare-earth magnet and the rare-earth magnet according to the present disclosure will be described below.

### [2.-1 Method for Producing Rare-Earth Magnet]

The method for producing a rare-earth magnet according to the present disclosure includes the provision step of providing the Sm—Fe-based alloy serving as a raw material, the hydrogenation-disproportionation step of subjecting to the Sm—Fe-based alloy to the hydrogenation-disproportionation treatment, the formation step of pressure-forming the Sm—Fe-based alloy that has been subjected to the hydrogenation-disproportionation treatment, the desorption-recombination step of subjecting the formed article obtained by pressure forming, and the nitriding step of subjecting the formed article that has been subjected to the desorption-recombination treatment to the nitriding treatment. The steps will be described in detail below.

### [2.-1-1 Provision Step]

The provision step is a step of providing a Sm—Fe-based alloy containing a SmFe_{9+α} phase (α=0.1 to 3.0) serving as a main phase, the SmFe_{9+α} phase having a mixed crystal structure including a SmFe₉ phase and amorphous Fe, by rapidly cooling a molten alloy containing Sm and Fe as main components in an atomic ratio of 1:8.75 to 1:12. The Sm—Fe-based alloy contains Sm and Fe as main components, has a composition in which the ratio of the number of atoms of Fe to one Sm atom is 8.75≤Fe/Sm≤12, and contains excess Fe, compared with the composition of Sm₂Fe₁₇. The term “main components” used here indicates that the total content of Sm and Fe accounts for 90 at % or more of the constituent elements of the Sm—Fe-based alloy. In the case where the atomic ratio Fe/Sm is less than 8.75, Sm₂Fe₁₇, which is more stable than SmFe₉, is formed to fail to sufficiently form SmFe₉. Thus, the SmFe_{9+α} phase is not easily formed. In the case where the atomic ratio Fe/Sm is more than 12, SmFe₁₃ is more easily formed than SmFe₉ to fail to sufficiently form SmFe₉. Thus, the SmFe_{9+α} phase is not easily formed.

For example, in the case of a Sm—Fe-based alloy consisting of Sm and Fe (containing incidental impurities) in an atomic ratio of Sm to Fe of 1:10, blending may be performed in such a manner that the content of Sm is 23% by mass and the balance is Fe.

The Sm—Fe-based alloy is an alloy obtained by rapidly cooling a molten alloy prepared so as to have a predetermined composition. The rapid cooling provides the SmFe₉ phase, which is a metastable phase and is more unstable than the Sm₂Fe₁₇ phase, thereby producing the Sm—Fe-based alloy containing the SmFe_{9+α} phase serving as a main phase, the SmFe_{9+α} phase having the mixed crystal structure including the SmFe₉ phase and amorphous Fe. A higher cooling rate results in further inhibition of the precipitation of α-Fe and the solidification in a mixed crystal state of the SmFe₉ phase and amorphous Fe to form the SmFe_{9+α} phase.

Furthermore, grain growth is inhibited to provide a fine microstructure. A low cooling rate results in the formation of Sm₂Fe₁₇ and the precipitation of α-Fe to easily form a single-crystal SmFe₉ phase. In addition, precipitated α-Fe is easily coarsened. The cooling rate is preferably 1×10⁶° C./s or more.

When the Sm—Fe-based alloy is subjected to X-ray diffraction with a Cu tube serving as a radiation source, the integrated intensity ratio of the integrated intensity Int(Fe) of a diffraction peak arising from the α-Fe(110) plane to the integrated intensity Int(SmFe) of a maximum diffraction peak arising from a compound of Sm and Fe is 1/9 or less in a range of 2θ=30° to 50°. The fact that the integrated intensity ratio, Int(Fe)/Int(SmFe), is 1/9 or less indicates a small amount of α-Fe precipitated in the alloy. A lower integrated intensity ratio results in more sufficient formation of the SmFe₉ phase, thereby seemingly leading to the formation of a large amount of the SmFe_{9+α} phase. The integrated intensity ratio, Int(Fe)/Int(SmFe), is preferably 0.1 or less, more preferably 0.05 or less. Particularly preferably, the integrated intensity ratio is less than 0.05, and substantially no α-Fe is present. Regarding a diffraction plane from which the maximum diffraction peak arising from the compound of Sm and Fe is obtained, in the case of isotropic crystal orientation, the maximum diffraction peak of the SmFe₉ structure arises from the (111) plane, and the maximum diffraction peak of the Sm₂Feᵣ structure arises from the (303) plane.

The foregoing Sm—Fe-based alloy can be produced by rapid cooling using, for example, a melt-spinning method. The melt-spinning method is a rapid cooling method in which a jet of a molten alloy is fed onto a cooled metal drum, resulting in a thin-film-like or thin-strip-like alloy. The resulting alloy may be pulverized into a powder as described below. In the melt-spinning method, the cooling rate can be controlled by changing the peripheral speed of the drum. Specifically, a higher peripheral speed of the drum results in a smaller thickness of the alloy and a higher cooling rate. The peripheral speed of the drum is preferably 30 m/s or more, even 35 m/s or more, more preferably 40 m/s or more. In general, when the peripheral speed of the drum is 35 m/s or more, the alloy has a thickness of about 10 to about 20 μm, and the cooling rate can be controlled to 1×10⁶° C./s or more. The upper limit of the peripheral speed of the drum is, for example, 100 m/s or less in view of production. When the alloy rapidly cooled by the melt-spinning method has an excessively large thickness, the alloy is less likely to be uniform. Accordingly, the alloy preferably has a thickness of 10 μm or more and 20 μm or less.

### [2.-1-2 Hydrogenation-Disproportionation Step]

The hydrogenation-disproportionation step is a step of subjecting the Sm—Fe-based alloy to the hydrogenation-disproportionation treatment by heat treatment in the hydrogen-containing atmosphere to decompose part of the SmFe_{9+α} phase into two phases of SmH₂ and Fe through a hydrogen disproportionation reaction. In this step, the hydrogenated alloy having the mixed crystal microstructure including the Fe phase, the SmH₂ phase, and the unreacted SmFe₉ phase is provided. In the hydrogenation-disproportionation treatment, the heat treatment is performed at a temperature equal to or higher than a temperature at which the hydrogen disproportionation reaction of the Sm—Fe-based alloy (SmFe_{9+α} phase) occurs. The initiation temperature of the hydrogen disproportionation reaction can be defined as follows: At room temperature (25° C.), a Sm—Fe-based alloy sample is placed in a gastight container filled with hydrogen at an internal pressured of 0.8 to 1.0 atm (81.0 to 101.3 kPa). The temperature of the container is raised.

The internal pressure when the temperature reaches 400° C. is expressed as P_{H2} (400° C.) [atm]. The minimum internal pressure in the temperature range of 400° C. to 900° C. is expressed as P_{H2} (MIN) [atm]. The difference between P_{H2} (400° C.) and P_{H2} (MIN) is expressed as ΔP_{H2} [atm]. The initiation temperature can be defined as a temperature in the range of 400° C. to 900° C. when the internal pressure is {P_{H2} (400° C.)−ΔP_{H2}×0.1} or less. If two or more temperatures fit the rule, the lowest temperature is defined as the initiation temperature. At this time, the weight of the sample is preferably set in such a manner that P_{H2} (MIN) is 0.5 atm (50.6 kPa) or less. A higher heat-treatment temperature in the hydrogenation-disproportionation treatment allows the phase decomposition of the SmFe_{9+α} phase to further proceed. The heat-treatment temperature in the hydrogenation-disproportionation treatment is preferably a temperature lower than a temperature at which P_{H2} (MIN) is obtained. This facilitates the phase decomposition of only part of the SmFe_{9+α} phase. Specifically, the heat-treatment temperature (hydrogenation-disproportionation temperature) in the hydrogenation-disproportionation treatment is, for example, higher than 500° C. and lower than 650° C., more preferably 525° C. or higher and 625° C. or lower.

The time of the hydrogenation-disproportionation treatment may be appropriately set and is, for example, 30 minutes or more and 180 minutes or less. An insufficient time of the hydrogenation-disproportionation treatment may result in insufficient phase decomposition of the SmFe_{9+α} phase. An excessively long time of the hydrogenation-disproportionation treatment may result in an excessive progress of the phase decomposition of the SmFe_{9+α} phase. Different times of the hydrogenation-disproportionation treatment also results in different proportions of the phase decomposition; thus, the microstructure of the hydrogenated alloy can be controlled.

Examples of the hydrogen-containing atmosphere include a H₂ gas atmosphere and mixed gas atmospheres each containing H₂ gas and an inert gas such as Ar or N₂. The atmosphere pressure (hydrogen partial pressure) of the hydrogen-containing atmosphere is, for example, 20.2 kPa (0.2 atm) or more and 1,013 kPa (10 atm) or less.

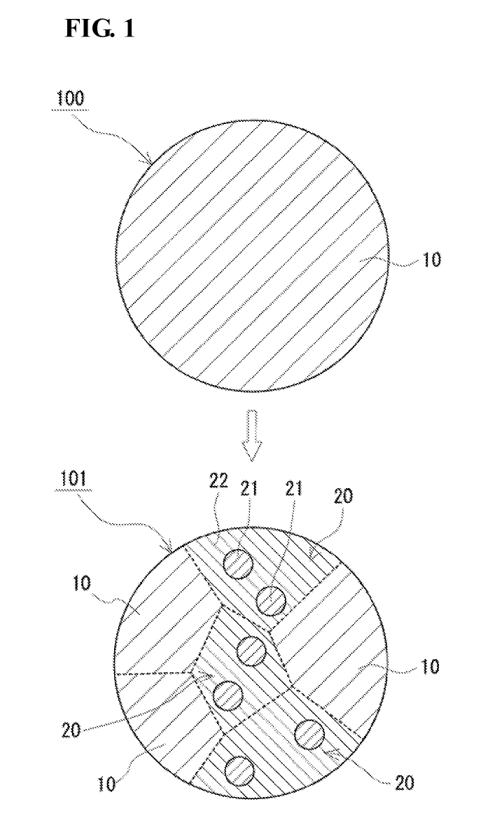

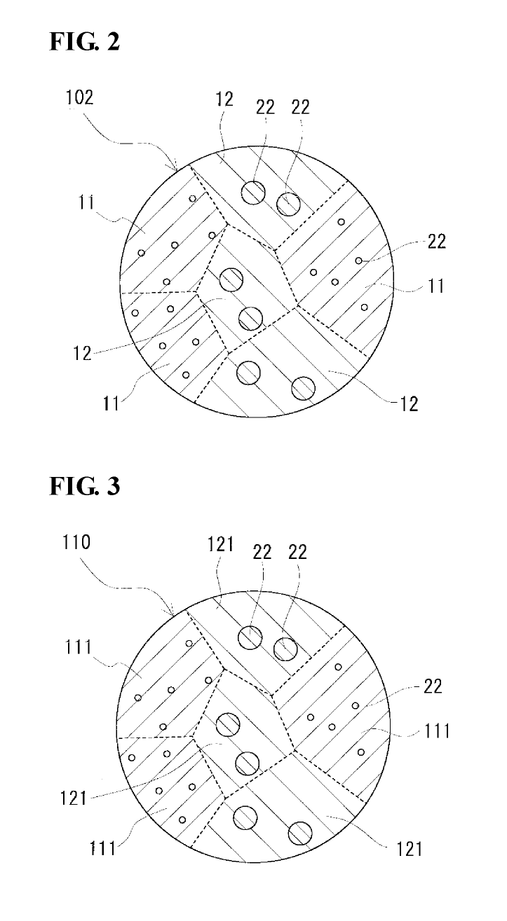

The crystalline microstructure of the Sm—Fe-based alloy (hydrogenated alloy) after the hydrogenation-disproportionation treatment is described with reference to FIG. 1. A Sm—Fe-based alloy 100 serving as a raw material, illustrated at the top of FIG. 1, is subjected to the hydrogenation-disproportionation treatment to allow part of SmFe_{9+α} phase 10 to undergo hydrogenolysis into SmH₂ and Fe, thereby forming a microstructure including a mixed crystal region 20 that includes the SmFe_{9+α} phase 10, a SmH₂ phase 21, and an Fe phase 22, as illustrated at the bottom of FIG. 1. In FIG. 1, for easy understanding, each of the phases constituting the microstructure is hatched (the same is true in FIGS. 2 and 3 described below). A hydrogenated alloy 101 thus obtained is easily plastically deformed and has improved formability because of the presence of the soft Fe phase 22 adjacent to the hard SmFe_{9+α} phase 10 and the hard SmH₂ phase 21. Accordingly, a high-density formed article can be obtained in the formation step described below. In the case where only part of the SmFe_{9+α} phase 10 included in the Sm—Fe-based alloy 100 serving as a raw material is subjected to phase decomposition, the mixed crystal region 20 is reduced in size, compared with the case where the whole of the SmFe_{9+α} phase is subjected to phase decomposition. Accordingly, when the SmH₂ phase 21 and the Fe phase 22 provided by phase decomposition in the hydrogenation-disproportionation treatment recombine in the desorption-recombination treatment in the desorption-recombination step described below, the formation of a coarse Fe phase is inhibited, thereby forming a fine microstructure.

The Sm—Fe-based alloy after the hydrogenation-disproportionation treatment preferably has a content of the SmFe₉ phase of 35% or more by volume and 60% or less by volume. This enables both the enhancement of the formability and the refinement of the microstructure. A lower percentage of the SmFe₉ phase results in a higher percentage of the mixed crystal region of the SmH₂ phase and the Fe phase formed by the phase decomposition of the SmFe_{9+α} phase. The increase of the Fe phase improves the formability.

When the mixed crystal region has a large size, a coarse Fe phase tends to be formed by the subsequent desorption-recombination treatment to decrease the magnetic properties. A higher percentage of the SmFe₉ phase results in a higher percentage of the remaining SmFe_{9+α} phase unreacted to cause a difficulty in plastic deformation and to degrade the formability; however, the coarsening of the Fe phase tends to be inhibited to form a fine nanocomposite microstructure. When the percentage of the SmFe₉ phase is 35% or more by volume and 60% or less by volume, the microstructure can be refined while the formability can be sufficiently enhanced. The volume percentage of the SmFe₉ phase is more preferably 40% or more.

The volume percentage of the SmFe₉ phase in the Sm—Fe-based alloy after the hydrogenation-disproportionation treatment can be determined as follows: The microstructure of a section of the alloy is observed with a scanning electron microscope (SEM) and subjected to composition analysis with an energy dispersive X-ray spectrometer (EDX) to separate and extract the SmFe₉ phase, the SmH₂ phase, and the Fe phase in the field of view. The area percentage of the SmFe₉ phase in the field of view is determined. The volume percentage can be determined by regarding the resulting area percentage of the phase as the volume percentage. The composition analysis may be performed with an appropriate analyzer other than the EDX.

### [2.-1-3 Formation Step]

The formation step is a step of pressure-forming the Sm—Fe-based alloy (hydrogenated alloy) that has been subjected to the hydrogenation-disproportionation treatment to provide a formed article. Specifically, the hydrogenated alloy is charged into a die set and pressure-formed with a pressing machine. The forming pressure in the pressure forming is, for example, 294 MPa (3 ton/cm²) or more and 1,960 MPa (20 ton/cm²) or less. The forming pressure is more preferably 588 MPa (6 ton/cm²) or more. The formed article preferably has a relative density of, for example, 80% or more. The upper limit of the relative density of the formed article is, for example, 95% or less in view of production. In the case where the pressure forming is performed, the application of a lubricant in advance on the internal surfaces of the die set facilitates the removal of the formed article from the die set. The term “relative density” used here refers to the actual density with respect to the true density (the percentage of [the actually measured density of the formed article/the true density of the formed article]). The true density is defined as the density of the Sm—Fe-Me-B-based alloy serving as a raw material.

### [2.-1-4 Pulverization Step]

The pulverization step of pulverizing the Sm—Fe-based alloy may be included before the formation step. The pulverization of the Sm—Fe-based alloy into a powder facilitates the charging operation of charging the alloy into the die set in the formation step. The pulverization step is performed before or after the hydrogenation-disproportionation step. The Sm—Fe-based alloy serving as a raw material may be pulverized. Alternatively, the hydrogenated alloy may be pulverized. The pulverization is preferably performed in such a manner that the alloy powder has a particle size of, for example, 5 mm or less, even 500 μm or less, particularly 300 μm or less. The pulverization may be performed with a known pulverizer such as a jet mill, a ball mill, a hammer mill, a braun mill, a pin mill, a disc mill, or a jaw crusher. When the alloy powder has a particle size of 10 μm or less, the filling properties of the alloy powder into the die set are degraded, and the influence of oxidation on the alloy powder is increased in the formation step; thus, the alloy powder preferably has a particle size of 10 μm or more. An atmosphere used in the pulverization is preferably an inert atmosphere in order to inhibit the oxidation of the alloy powder. An oxygen concentration in the atmosphere is preferably 5% or less by volume, even 1% or less by volume. Examples of the inert atmosphere include atmospheres of inert gases such as Ar and N₂.

### [2.-1-5 Desorption-Recombination Step]

The desorption-recombination step is a step of subjecting the formed article composed of the Sm—Fe-based alloy (hydrogenated alloy) that has been subjected to the hydrogenation-disproportionation treatment to the desorption-recombination treatment by heat treatment in an inert atmosphere or a reduced-pressure atmosphere to allow SmH₂ and Fe provided by phase decomposition in the hydrogenation-disproportionation treatment to recombine into the Sm₂Fe₁₇ phase through a recombination reaction. In this step, a mixed crystal body having a nanocomposite mixed crystal microstructure including the Fe phase, the Sm₂Fe₁₇ phase, and the SmFe₉ phase is formed. In the desorption-recombination treatment, the heat treatment is performed at a temperature equal to or higher than a temperature at which the recombination reaction of SmH₂ and Fe provided by phase decomposition in the hydrogenation-disproportionation treatment occurs. The heat-treatment temperature (desorption-recombination temperature) in the desorption-recombination treatment is preferably such that SmH₂ is not detected (substantially no SmH₂ is present) in the central portion of the formed article (a portion most distant from the outer surface of the formed article). For example, the heat-treatment temperature is 600° C. or higher and 1,000° C. or lower. A higher heat-treatment temperature in the desorption-recombination treatment allows the recombination reaction to further proceed. However, an excessively high heat-treatment temperature may result in the coarsening of the crystalline microstructure. The heat-treatment temperature in the desorption-recombination treatment is more preferably 650° C. or higher and 800° C. or lower.

The time of the desorption-recombination treatment may be appropriately set and is, for example, 30 minutes or more and 180 minutes or less. An insufficient time of the desorption-recombination treatment may result in the failure of the recombination reaction to proceed sufficiently to the inside of the formed article. An excessively long time of the desorption-recombination treatment may result in the coarsening of the crystalline microstructure.

As the inert atmosphere, for example, an inert gas atmosphere such as Ar or N₂ is used. As the reduced-pressure atmosphere, for example, a vacuum atmosphere having a degree of vacuum of 10 Pa or less is used. More preferably, the degree of vacuum of the vacuum atmosphere is 1 Pa or less, even 0.1 Pa or less. In particular, when the desorption-recombination treatment is performed in the reduced-pressure atmosphere (vacuum atmosphere), the recombination reaction proceeds easily, so that the SmH₂ phase is not easily left. In the case where the formed article has a high density or a large size, if the pressure is rapidly reduced to 10 Pa or less in the desorption-recombination treatment in the vacuum atmosphere, the reaction may proceed only on surface layers of the formed article to cause the surface layers to shrink, thereby possibly closing voids to impede hydrogen release from the inside of the formed article. Accordingly, when the desorption-recombination treatment is performed in the vacuum atmosphere, the degree of vacuum is preferably controlled. For example, the degree of vacuum is preferably controlled as follows: The temperature is raised to a desorption-recombination temperature in the hydrogen-containing atmosphere at a pressure of 20 to 101 kPa. Then the pressure of the hydrogen-containing atmosphere is reduced to a degree of vacuum of, for example, about 0.1 to about 20 kPa. Ultimately, the degree of vacuum is 10 Pa or less. The same is true for the case where the alloy powder constituting the formed article has a large particle size.

The crystalline microstructure of the formed article (mixed crystal body) after the desorption-recombination treatment is described with reference to FIG. 2. The desorption-recombination treatment of the hydrogenated alloy 101 illustrated at the bottom of FIG. 1 recombines the SmH₂ phase 21 and the Fe phase 22 together in the mixed crystal region 20 to form a mixed crystal microstructure containing the Fe phase 22 and a Sm₂Fe₁₇ phase 12 in a nano-sized scale as illustrated in FIG. 2. In the desorption-recombination treatment, Fe is precipitated in thee SmFe_{9+α} phase 10 to form a mixed crystal microstructure containing the fine nano-sized Fe phase 22 dispersed in a SmFe₉ phase 11. Accordingly, in the resulting mixed crystal body 102, a nanocomposite mixed crystal microstructure including the Fe phase 22, the Sm₂Fe₁₇ phase 12, and the SmFe₉ phase 11 is formed.

### [2.-1-6 Nitriding Step]

The nitriding step is a step of subjecting the formed article (mixed crystal body) that has been subjected to the desorption-recombination treatment to nitriding treatment by heat treatment in a nitrogen-containing atmosphere. In this step, the Sm₂Fe₁₇ phase and the SmFe₉ phase in the mixed crystal body are nitrided to provide a compacted rare-earth magnet having a nanocomposite mixed crystal microstructure including the Fe phase, the Sm₂Fe₁₇Nₓ phase, and the SmFe₉N_{y} phase. The heat-treatment temperature in the nitriding treatment is, for example, 200° C. or higher and 550° C. or lower. A higher heat-treatment temperature in the nitriding treatment allows nitriding to further proceed. However, an excessively high heat-treatment temperature may result in the coarsening of the crystalline microstructure and excessive nitriding to degrade the magnetic properties. The heat-treatment temperature in the nitriding treatment is more preferably 300° C. or higher and 500° C. or lower. The time of the nitriding treatment may be appropriately set and is, for example, 60 minutes or more and 1,200 minutes or less.

Examples of the nitrogen-containing atmosphere include an NH₃ gas atmosphere, a mixed-gas atmosphere of NH₃ gas and H₂ gas, a N₂ gas atmosphere, and a mixed-gas atmosphere of N₂ gas and H₂ gas.

The crystalline microstructure of the rare-earth magnet after the nitriding treatment is described with reference to FIG. 3. The nitriding treatment of the mixed crystal body 102 illustrated in FIG. 2 nitrides the Sm₂Fe₁₇ phase 12 and the SmFe₉ phase 11 to form the nanocomposite mixed crystal microstructure including the Fe phase 22, a Sm₂Fe₁₇Nₓ phase 121, and a SmFe₉N_{y} phase 111 as illustrated in FIG. 3. In the resulting rare-earth magnet 110, the atomic ratio x of N in the Sm₂Fe₁₇Nₓ phase 121 is, for example, 2.0≤x≤3.5, preferably x=3. The atomic ratio y of N in the SmFe₉N_{y} phase 111 is, for example, 0.5≤y≤2.0, preferably y=1.8. The Fe phase 22 has an average grain size of 200 nm or less, preferably 100 nm or less. The average grain size of the Fe phase can be determined by direct observation with a transmission electron microscope (TEM). In addition, the average grain size can be determined by the Scherrer equation using the full width at half maximum of a diffraction peak obtained by X-ray diffraction. Furthermore, the average grain size can be determined as a dispersed particle size by an indirect method using an X-ray diffraction peak at a very low angle.

In the crystalline microstructure of the rare-earth magnet, the following two types of Fe phases are present: an Fe phase precipitated as an excess component at grain boundary portions of Sm₂Fe₁₇ crystals when the SmH₂ phase and the Fe phase formed by the hydrogen disproportionation reaction in the hydrogenation-disproportionation treatment recombine in the desorption-recombination treatment into the Sm₂Fe₁₇ phase; and an Fe phase in which Fe corresponding to a in the remaining SmFe_{9+α} phase undecomposed in the hydrogenation-disproportionation treatment is precipitated by pyrolysis in the SmFe₉ crystals. In the case where the heat-treatment temperature of each of the hydrogenation-disproportionation treatment and the desorption-recombination treatment is 700° C. or lower, the size of the former Fe phase tends to be larger than that of the latter Fe phase. The former Fe phase tends to have an odd shape, whereas the latter Fe phase tends to have a spherical shape. The former Fe phase and the latter Fe phase can be distinguished from each other by evaluating the roundness of the Fe phases through the observation of the microstructure. The term “roundness” used here refers to a value obtained by dividing a circular-equivalent diameter by a maximum diameter.

### [2.-2 Rare-Earth Magnet]

The rare-earth magnet according to the present disclosure can be produced by the production method described above, has the nanocomposite mixed crystal microstructure including the Fe phase, the Sm₂Fe₁₇Nₓ phase, and the SmFe₉N_{y} phase, and has a relative density of 80% or more. The rare-earth magnet is a compacted magnet that is composed of the Sm—Fe—N-based alloy having the Fe/Sm₂Fe₁₇Nₓ/SmFe₉N_{y} nanocomposite mixed crystal microstructure and that includes the soft magnetic phase formed of the Fe phase and the hard magnetic phases formed of the Sm₂Fe₁₇Nₓ phase (x=2.0 to 3.5) and the SmFe₉N_{y} phase (y=0.5 to 2.0). The presence of the fine nano-sized Fe phase results in the exchange interaction between the soft magnetic phase and the hard magnetic phases to enable the rare-earth magnet to have both high magnetization and high coercive force. The rare-earth magnet does not contain a binder and has a relative density of 80% or more; thus, the percentage of the Sm—Fe—N-based alloy is high, thereby providing performance close to intrinsic magnetic properties of the Sm—Fe—N-based alloy.

### [2.-2-1 Magnetic Properties]

The rare-earth magnet has high remanent magnetization and high coercive force and has good magnetic properties.

For example, the remanent magnetization is 0.58 T or more, and the coercive force is 480 kA/m or more. The remanent magnetization is preferably 0.60 T or more, more preferably 0.70 T or more. The coercive force is preferably 500 kA/m or more.

### Test Example 1

Samples of rare-earth magnets (Nos. 1-11 to 1-53) were produced with Sm—Fe-based alloys containing Sm and Fe in different atomic ratios and were evaluated.

Molten alloys containing Sm and the balance being Fe and incidental impurities were rapidly cooled by a melt-spinning method to produce Sm—Fe-based alloys serving as starting materials. The resulting Sm—Fe-based alloys were pulverized in an inert atmosphere and then screened into Sm—Fe-based alloy powders having a particle size of 106 μm or less. In test example 1, different Sm contents were used, and various Sm—Fe-based alloys in which the atomic ratios of Fe to Sm, i.e., Fe/Sm, were 8 to 12.5 were provided. The Sm—Fe-based alloys were rapidly cooled at different peripheral speeds of a drum. Table 1 lists the atomic ratios Fe/Sm of the resulting Sm—Fe-based alloys and the peripheral speeds of the drum.

Each of the Sm—Fe-based alloys serving as raw materials was subjected to X-ray diffraction using an X-ray diffractometer SmartLab, available from Rigaku Corporation) equipped with a Cu tube serving as a radiation source. In the X-ray diffraction, the integrated intensity ratio of the integrated intensity Int(Fe) of a diffraction peak arising from the α-Fe(110) plane to the integrated intensity Int(SmFe) of a maximum diffraction peak arising from a compound of Sm and Fe is 1/9 or less in the range of 2θ=30° to 50° was determined. Table 1 lists the integrated intensity ratios Int(Fe)/Int(SmFe) of the Sm—Fe-based alloys. In Table 1, the expression “<0.05” in the integrated intensity ratio column indicates that the integrated intensity ratio was less than 0.05 and α-Fe was not detectable because it was less than the detection limit.

Each of the provided Sm—Fe-based alloy powders was subjected to hydrogenation-disproportionation treatment in a H₂ gas atmosphere (atmospheric pressure) to provide a hydrogenated alloy powder. In the hydrogenation-disproportionation treatment, the heat-treatment temperature was 575° C., and the treatment time was 150 minutes. In each hydrogenated alloy powder, the volume percentage of a SmFe₉ phase was determined by observation of the microstructures of sections of the particles thereof with a scanning electron microscope (SEM) and by composition analysis with an energy dispersive X-ray spectrometer (EDX). Here, 10 or more particle sections were observed with a SEM-EDX instrument (JSM-7600F, available from JEOL, Ltd). The area percentage of the SmFe₉ phase in each particle was determined. The average value thereof was regarded as the volume percentage of the SmFe₉ phase. Table 1 lists the volume percentage of the SmFe₉ phase in each hydrogenated alloy powder.

Each of the hydrogenated alloy powders was charged into a die set and pressure-formed to provide a cylindrical hydrogenated alloy powder compact having a diameter of 10 mm and a height of 10 mm. The pressure forming was performed at a forming pressure of 1,470 MPa (15 ton/cm²) at room temperature. A lubricant (myristic acid) was applied to inner surfaces of the die set. The relative density of each of the resulting compacts was determined. The relative density of the compact was calculated by measuring the volume and the mass of the compact, determining a measured density from these values, and regarding the density of the raw-material Sm—Fe-based alloy as the true density. Table 1 lists the relative density of each compact.

The temperature of each of the resulting compacts was raised in a H₂ gas atmosphere (atmospheric pressure). After the temperature reached a predetermined desorption-recombination temperature, the atmosphere was switched to a vacuum atmosphere (with a degree of vacuum of 10 Pa or less) to perform desorption-recombination treatment, thereby providing a mixed crystal body. The desorption-recombination treatment was performed at a heat-treatment temperature of 650° C. for a treatment time of 150 minutes. Then the resulting compacts were subjected to nitriding treatment in a mixed gas atmosphere of NH₃ gas and H₂ gas (the volume mixing ratio of NH₃ gas to H₂ gas was 1:2) to provide samples (Nos. 1-11 to 1-53) of compacted rare-earth magnets listed in Table 1. The nitriding treatment was performed at a heat-treatment temperature of 350° C. for a treatment time of 720 minutes. The relative densities of the resulting compacted magnets were determined. Each of the samples had a relative density substantially equal to the relative density of a corresponding one of the hydrogenated alloy powder compacts before the desorption-recombination treatment and the nitriding treatment.

A sample (No. 101) of a bonded magnet was produced for comparison. In the case of this sample, a Sm—Fe-based alloy, serving as a starting material, in which the atomic ratio Fe/Sm was 13.6, was produced by rapid cooling by a melt-spinning method. The resulting alloy was pulverized and screened into a Sm—Fe-based alloy powder having a particle size of 70 μm or more and 150 μm or less. The peripheral speed of the drum was 50 m/s. Then the Sm—Fe-based alloy powder was heat-treated at 720° C. for 1 hour in an Ar gas atmosphere (1 atm). The resulting Sm—Fe-based alloy was subjected to X-ray diffraction. As with the foregoing samples of the compacted magnets, the integrated intensity ratio Int(Fe)/Int(SmFe) was determined. Table 1 lists the results.

As with the foregoing samples of the compacted magnets, the volume percentage of the SmFe₉ phase in the resulting Sm—Fe-based alloy powder was determined. Table 1 lists the results.

Subsequently, the resulting Sm—Fe-based alloy powder was subjected to nitriding treatment at 450° C. for 10 hours in a N₂ gas atmosphere (1 atm) to provide a magnetic powder of a mixed crystal alloy including an Fe phase and a Sm—Fe—N phase. The resulting magnetic powder was mixed with 4% by mass of an epoxy resin powder serving as a binder. The powder mixture was charged into a die set and pressure-formed at a temperature of 150° C. and a forming pressure of 50 MPa to provide the sample (No. 101) of a bonded rare-earth magnet. The bonded magnet had a cylindrical shape with a diameter of 10 mm and a height of 10 mm. The relative density of the bonded magnet was presented in Table 1. The relative density of the bonded magnet was calculated by determining the measured density of the bonded magnet and regarding the density of the Sm—Fe-based alloy serving as a raw material as the true density.

Magnetic properties of the rare-earth magnets of the resulting samples were evaluated. Specifically, magnetization treatment was performed by the application of a pulsed magnetic field of 4,777 kA/m (5 T) with a magnetizer (Model SR, high-voltage capacitor type, available from Nihon Denji Sokki Co., Ltd). A B—H curve was measured with a BH tracer (DCBH tracer, available from Riken Denshi Co., Ltd.) to determine the saturation magnetization, the remanent magnetization, and the coercive force. The saturation magnetization was a value when a magnetic field of 2,388 kA/m was applied. Table 1 lists the saturation magnetization, the remanent magnetization, and the coercive force of each sample.

TABLE 1

| | | | | Hydrogenated alloy | | | | | |
|---|---|---|---|---|---|---|---|---|---|
| | Material alloy | | | | Percentage | | | | |
| | | | Integrated | Hydrogenation- | of | Compact | | | |
| | | Peripheral | intensity | disproportionation | SmFe₉ | Relative | Magnet | | |
| | Atomic | speed of | ratio | treatment | phase | density | Saturation | Remanent | Coercive |
| Sample | ratio | drum | Int (Fe)/Int | temperature | (% by | (% by | magnetization | magnetization | force |
| No. | Fe/Sm | (m/s) | (SmFe) | (° C.) | volume) | volume) | (T) | (T) | (kA/m) |
| 1-11 | 8 | 30 | <0.05 | 575 | 0 | 76 | 0.95 | 0.46 | 560 |
| 1-12 | 8 | 40 | <0.05 | 575 | 0 | 81 | 1.02 | 0.50 | 600 |
| 1-13 | 8 | 60 | <0.05 | 575 | 0 | 84 | 1.05 | 0.57 | 630 |
| 1-21 | 8.75 | 30 | <0.05 | 575 | 4 | 84 | 1.22 | 0.60 | 520 |
| 1-22 | 8.75 | 40 | <0.05 | 575 | 16 | 86 | 1.23 | 0.66 | 570 |
| 1-23 | 8.75 | 60 | <0.05 | 575 | 35 | 87 | 1.23 | 0.72 | 510 |
| 1-31 | 10 | 30 | 0.08 | 575 | 26 | 85 | 1.23 | 0.61 | 520 |
| 1-32 | 10 | 40 | <0.05 | 575 | 38 | 82 | 1.22 | 0.73 | 530 |
| 1-33 | 10 | 60 | <0.05 | 575 | 51 | 80 | 1.24 | 0.75 | 550 |
| 1-41 | 12 | 30 | 0.15 | 575 | 3 | 82 | 1.28 | 0.51 | 360 |
| 1-42 | 12 | 40 | 0.05 | 575 | 10 | 82 | 1.27 | 0.58 | 480 |
| 1-43 | 12 | 60 | <0.05 | 575 | 37 | 81 | 1.27 | 0.73 | 520 |
| 1-51 | 12.5 | 30 | <0.05 | 575 | 0 | 60 | 0.86 | 0.33 | 230 |
| 1-52 | 12.5 | 40 | <0.05 | 575 | 0 | 58 | 0.84 | 0.42 | 320 |
| 1-53 | 12.5 | 60 | <0.05 | 575 | 5 | 58 | 0.82 | 0.43 | 360 |
| 101 | 13.6 | 50 | <0.05 | 600 | 65 | 63 | 0.98 | 0.34 | 120 |

The results presented in Table 1 indicate that in sample Nos. 1-21 to 1-23, 1-31 to 1-33, 1-42, and 1-43 of the compacted magnets produced from the Sm—Fe-based alloys, serving as raw materials, in which the atomic ratios Fe/Sm are 8.75 to 12 and in which the integrated intensity ratios are 1/9 (about 0.11) or less, the compacts have a relative density of 80% or more and a higher saturation magnetization than the bonded magnet. These samples have a remanent magnetization of 0.58 T or more and a coercive force of 480 kA/m or more and thus have high remanent magnetization and high coercive force. Observation and composition analysis of the microstructure of a section of each of the resulting samples with the SEM-EDX instrument indicated that Fe/Sm₂Fe₁₇Nₓ (x=2.0 to 3.5)/SmFe₉N_{y} (y=0.5 to 2.0) nanocomposite mixed crystal microstructures were formed.

In particular, among these samples, sample Nos. 1-23, 1-32, 1-33, and 1-43, in which the integrated intensity ratios are less than 0.05 and in which the percentage of the SmFe₉ phase in the hydrogenated alloys was 35% to 60% by volume, have a remanent magnetization of 0.70 T or more and a coercive force of 500 kA/m or more and thus have significantly improved magnetic properties. Sample Nos. 1-23, 1-32, 1-33, and 1-43 were subjected to X-ray diffraction. The average grain size of the Fe phase thereof was determined from the Scherrer equation using the full width at half maximum of a diffraction peak. In each of the samples, the average grain size of the Fe phase was in the range of 80 nm or more and 120 nm.

Possible reasons sample Nos. 1-11 to 1-13 and 1-51 to 1-53 had degraded magnetic properties are as follows: In sample Nos. 1-11 to 1-13, the atomic ratio Fe/Sm of each of the alloys serving as raw materials was 8; thus, Sm₂Fe₁₇, which is more stable than SmFe₉, is formed to cause a difficulty in forming the SmFe_{9+α} phase. Hence, ultimately, a fine nanocomposite microstructure is not formed, degrading the magnetic properties. In sample Nos. 1-51 to 1-53, the atomic ratio Fe/Sm is 12.5; thus, the resulting microstructure is stabilized in a state close to a SmFe₁₃ structure rather than SmFe₉, thereby causing a difficulty in forming the SmFe_{9+α} phase. The SmFe₁₃ is not easily subjected to hydrogenolysis and is hard; thus, a fine microstructure is not formed, and the compacts have a low relative density, degrading the magnetic properties.

A possible reason sample No. 1-41 had degraded magnetic properties is as follows: Because this sample contains a relatively large amount of excess Fe, α-Fe is easily precipitated when the peripheral speed of the drum is low.

Thus, the alloy serving as a raw material contains a large amount of coarse α-Fe, and the integrated intensity ratio is more than 1/9. Because of the low peripheral speed of the drum, a single-crystal SmFe₉ phase is easily formed, whereas the SmFe_{9+α} phase is not easily formed. Accordingly, a fine microstructure is not formed, thereby degrading the magnetic properties.

### Test Example 2

Samples (Nos. 2-31 to 2-34) of rare-earth magnets presented in Table 2 were produced at different heat-treatment temperatures in the hydrogenation-disproportionation treatment of Sm—Fe-based alloys and were evaluated.

In test example 2, the same Sm—Fe-based alloy powders as that in sample No. 1-32 of test example 1 was provided as a starting material. Samples (Nos. 2-31 to 2-34) of compacted rare-earth magnets were produced under the same production conditions as in test example 1, except that the heat-treatment temperature in the hydrogenation-disproportionation treatment was changed in the range of 500° C. to 650° C. Table 2 lists the evaluation results.

TABLE 2

| | | | | Hydrogenated alloy | | | | | |
|---|---|---|---|---|---|---|---|---|---|
| | Material alloy | | | | Percentage | | | | |
| | | | Integrated | Hydrogenation- | of | Compact | | | |
| | | Peripheral | intensity | disproportionation | SmFe₉ | Relative | Magnet | | |
| | Atomic | speed of | ratio | treatment | phase | density | Saturation | Remanent | Coercive |
| Sample | ratio | drum | Int (Fe)/Int | temperature | (% by | (% by | magnetization | magnetization | force |
| No. | Fe/Sm | (m/s) | (SmFe) | (° C.) | volume) | volume) | (T) | (T) | (kA/m) |
| 2-31 | 10 | 40 | <0.05 | 500 | 74 | 71 | 1.09 | 0.57 | 630 |
| 2-32 | 10 | 40 | <0.05 | 525 | 60 | 80 | 1.24 | 0.74 | 530 |
| 1-32 | 10 | 40 | <0.05 | 575 | 38 | 82 | 1.22 | 0.73 | 530 |
| 2-33 | 10 | 40 | <0.05 | 600 | 35 | 84 | 1.27 | 0.72 | 500 |
| 2-34 | 10 | 40 | <0.05 | 650 | 27 | 85 | 1.28 | 0.62 | 410 |

The results presented in Table 2 indicate that in sample Nos. 2-32, 1-32, and 2-33, in which the heat-treatment temperature in the hydrogenation-disproportionation treatment is higher than 500° C. and lower than 650° C., the percentage of the SmFe₉ phase in the hydrogenated alloy is 35% to 60% by volume, and the compacts have a relative density of 80% or more. These samples have a remanent magnetization of 0.70 T or more and a coercive force of 500 kA/m or more and thus have high remanent magnetization and high coercive force. A possible reason for this is as follows: because the percentage of the SmFe₉ phase is 35% to 60% by volume, the refinement of the Fe phase results in significantly improved magnetic properties while the formability can be sufficiently enhanced.

In contrast, in sample No. 2-31, in which the heat-treatment temperature in the hydrogenation-disproportionation treatment is 500° C., the percentage of the SmFe₉ phase in the hydrogenated alloy is more than 60% by volume, and the compact has a low relative density. A possible reason for this is as follows: The low heat-treatment temperature results in insufficient phase decomposition of the SmFe_{9+α} phase to increase the percentage of the remaining SmFe_{9+α} phase unreacted, thereby degrading the formability. In sample No. 2-34, in which the heat-treatment temperature in the hydrogenation-disproportionation treatment is 650° C., the percentage of the SmFe₉ phase in the hydrogenated alloy is less than 35% by volume. The compact has a high relative density, but has degraded magnetic properties such as remanent magnetization and coercive force. A possible reason for this is as follows: The high heat-treatment temperature results in an increase in the percentage of the Fe phase formed by hydrogenolysis of the SmFe_{9+α} phase. The subsequent desorption-recombination treatment leads to the formation of a coarse Fe phase to fail to form a fine microstructure, degrading the magnetic properties.

The embodiments disclosed herein are to be considered in all respects as illustrative and not limiting. The scope of the invention is defined not by the foregoing description but by the following claims, and is intended to include any modifications within the scope and meaning equivalent to the scope of the claims.

### REFERENCE SIGNS LIST

100 Sm—Fe-based alloy, 10 SmFe_{9+α} phase, 101 hydrogenated alloy, 20 mixed crystal region,21 SmH₂ phase, 22 Fe phase, 102 mixed crystal body,
11 SmFe₉ phase, 12 Sm₂Fe₁₇ phase, 110 rare-earth magnet, 111 SmFe₉N_{y} phase, 121 Sm₂Fe₁₇Nₓ phase

1. A method for producing rare-earth magnet, comprising:
a provision step of providing a Sm—Fe-based alloy containing a SmFe_{9+α} phase serving as a main phase, the SmFe_{9+α} phase having a mixed crystal structure including a SmFe₉ phase and amorphous Fe, by rapidly cooling a molten alloy containing Sm and Fe as main components in an atomic ratio of 1:8.75 to 1:12;
a hydrogenation-disproportionation step of subjecting the Sm—Fe-based alloy to hydrogenation-disproportionation treatment by heat treatment in a hydrogen-containing atmosphere to decompose part of the SmFe_{9+α} phase (α=0.1 to 3.0) into two phases of SmH₂ and Fe through a disproportionation reaction;
a formation step of pressure-forming the Sm—Fe-based alloy that has been subjected to the hydrogenation-disproportionation treatment to provide a formed article;
a desorption-recombination step of subjecting the formed article to desorption-recombination treatment by heat treatment in an inert atmosphere or a reduced-pressure atmosphere to allow the SmH₂ and the Fe provided by phase decomposition in the hydrogenation-disproportionation treatment to recombine through a recombination reaction; and
a nitriding step of subjecting the formed article that has been subjected to the desorption-recombination treatment to nitriding treatment by heat treatment in a nitrogen-containing atmosphere,
wherein when the Sm—Fe-based alloy obtained in the provision step is subjected to X-ray diffraction with a Cu tube serving as a radiation source, an integrated intensity ratio of integrated intensity Int(Fe) of a diffraction peak arising from an α-Fe(110) plane to integrated intensity Int(SmFe) of a maximum diffraction peak arising from a compound of Sm and Fe is 1/9 or less in a range of 2θ=30° to 50°.

2. The method for producing a rare-earth magnet according to claim 1, wherein in the hydrogenation-disproportionation step, the Sm—Fe-based alloy that has been subjected to the hydrogenation-disproportionation treatment has a content of the SmFe₉ phase of 35% or more by volume and 60% or less by volume.

3. The method for producing a rare-earth magnet according to claim 1, further comprising a pulverization step of pulverizing the Sm—Fe-based alloy before the formation step.

4. The method for producing a rare-earth magnet according to claim 1, wherein the heat treatment in the hydrogenation-disproportionation step is performed at a temperature higher than 500° C. and lower than 650° C.

5. The method for producing a rare-earth magnet according to claim 1, wherein in the provision step, the Sm—Fe-based alloy is produced by rapid cooling using a melt-spinning method.

6. A rare-earth magnet comprising a nanocomposite mixed crystal microstructure including an Fe phase, a Sm₂Fe₁₇Nₓ phase, and a SmFe₉N_{y} phase,
wherein the rare-earth magnet has a relative density of 80% or more.
